(19) United States
(12) Patent Application Publication
(10) Pub. No.: US 2014/0028667 A1
(43) Pub. Date: Jan. 30, 2014

(54) Three-Dimensional Representation of Objects

(71) Applicants: Bernd Spruck, Mögglingen (DE); Christina Alvarez Diez, Aalen (DE); Christian Wojek, Aalen (DE); Jochen Fuchs, Neu-Ulm (DE)

(72) Inventors: Bernd Spruck, Mögglingen (DE); Christina Alvarez Diez, Aalen (DE); Christian Wojek, Aalen (DE); Jochen Fuchs, Neu-Ulm (DE)

(21) Appl. No.: 13/953,248

(22) Filed: Jul. 29, 2013

(30) Foreign Application Priority Data
Jul. 30, 2012 (DE) 10 2012 106 890.9

(51) Int. Cl. G06T 19/20

(52) U.S. Cl. CPC G06T 19/20
USPC 345/419

(57) ABSTRACT

Methods and apparatuses are provided, with which a first 3D representation, for example on the basis of a laser scanning micrograph, with a second 3D representation, for example on the basis of an optical micrograph, are represented in superimposed manner on a suitable 3D display. Methods and apparatuses of such a type can be used, in particular, for the purpose of cutting objects.

### CROSS REFERENCE TO RELATED APPLICATION

This application claims the priority, under 35 U.S.C. Section 119, of co-pending German Published Patent Application No. DE 10 2012 106 890.9, filed Jul. 30, 2012, the prior application is herewith incorporated by reference herein in its entirety.

### FIELD OF THE INVENTION

The present invention relates to the three-dimensional representation (3D representation) of objects on suitable display devices, for example, based upon measured data, in particular, data obtained by microscopic measurements, and also to methods and apparatuses for object manipulation that utilise a 3D representation of such a type.

### BACKGROUND OF THE INVENTION

1. Technical Field

The present invention relates to the three-dimensional representation (3D representation) of objects on suitable display devices, for example on the basis of measured data, in particular data obtained by microscopic measurements, and also to methods and apparatuses for object manipulation that utilise a 3D representation of such a type.

2. Background

In microscopy there are various possibilities for obtaining three-dimensional data pertaining to an object. For example, an object can be scanned by means of a so-called laser scanning microscope, in order in this way to obtain a three-dimensional data record (3D data record). In cell analysis, for example, regions of an object that are of interest can be detected here which later can be examined further by means of other methods, for example electron microscopy.

For such an electron-microscopic examination of an object it is necessary to prepare the object appropriately beforehand, in particular to cut it, for example by means of a microtome, in order to expose a site to be examined. This can be undertaken, for example, while viewing with a stereomicroscope. In this case the difficulty arises of placing the incision accurately in such a way that the site of interest registered previously, for example by means of the laser scanning microscope, is in fact also exposed.

Therefore in this case it would be useful if the data registered by means of the laser scanning microscope were directly accessible during the cutting procedure and during the viewing of the object in the course of the cutting or at least in the course of an alignment for the cutting procedure.

Also in other applications it may be useful to be able to adjust a 3D data record, which, for example, was obtained by a measurement or also in some other way, for example by simulation, with other three-dimensional representations of an object, for example under a stereomicroscope.

### BRIEF SUMMARY OF THE INVENTION

Methods and apparatuses for three-dimensional representation are provided, with which such an adjustment of data originating from various sources is possible in straightforward manner. Furthermore, methods and apparatuses for manipulating, in particular, for cutting, objects, in particular, for the purpose of preparing for electron-microscopic examinations using methods and apparatuses of such a type for the purpose of three-dimensional representation, are provided.

In accordance with an embodiment a method is provided, comprising: providing a first three-dimensional data record of an object, providing a second three-dimensional data record of an object, relative aligning of a three-dimensional representation on the basis of the first three-dimensional data record with respect to a second three-dimensional representation on the basis of the second three-dimensional data record, and superimposed displaying of the first three-dimensional representation of the object and the second three-dimensional representation of the object.

By virtue of the relative aligning and the superimposed displaying, in this method the first three-dimensional representation and the second three-dimensional representation can be viewed simultaneously and aligned with respect to one another, so that, for example, features from the first three-dimensional data record can easily be adjusted with features of the second three-dimensional data record.

The superimposed displaying in this method may be undertaken on a suitable display device for representing three-dimensional images, for example by means of a so-called 3D monitor, a suitable head-mounted display, 3D goggles or such like, which are capable of providing separate images for the left and right eye of an observer. With a view to superimposed representation in this method, the first three-dimensional representation and the second three-dimensional representation can, for example, be represented alternately with sufficiently high alternating frequency, for example higher than 30 Hz. In another embodiment, a display can be split between the first three-dimensional representation and the second three-dimensional representation, for example line-by-line or in a chessboard-like pattern, so that the first and the second three-dimensional representations are represented simultaneously. In yet other embodiments the representations can be added. The first and the second three-dimensional representations and also the superimposition in this method may be respectively, in particular, stereoscopic representations with an image for the left eye of an observer and with an image for the right eye of an observer.

In many embodiments the first three-dimensional data record may be a stored data record, for example a data record acquired on the basis of a preceding measurement (for example a measurement with a laser scanning microscope) or a data record acquired on the basis of a simulation or a design such as a CAD design. The second three-dimensional data record may likewise be a stored data record of such a type. In a preferred embodiment, the second three-dimensional data record is, however, a data record that is continuously renewed in routine operation and that, for example, can be acquired by recording with the aid of a stereomicroscope. In the case of a stereomicroscope, the data record is then a stereoscopic data record. For the purpose of recording in this method, eyepieces of the stereomicroscope may, for example, have been replaced by cameras. In this way, for example, a previously stored first three-dimensional data record can be adjusted with a second three-dimensional data record acquired ‘live’. With the aid of a continuously renewed data record of such a type, manipulations of the object, for example cutting procedures, can then, for example, be monitored and carried out, whereas the superimposed representation of the first three-dimensional data record may be useful to take into account features detected and, where appropriate, marked in the course of a manipulation of such a type, for example by a measuring method carried out previously, for example to expose them.

The relative aligning may, for example, be undertaken automatically, semi-automatically or manually on the basis of features of the object, for example on the basis of fluorescent beads that have been excited to fluoresce.

In another embodiment, an apparatus includes a first three-dimensional data source for providing a first three-dimensional data record of an object, a second three-dimensional data source for providing a second three-dimensional data record of a object, a computing unit for relative aligning of a first three-dimensional representation of the object on the basis of the first three-dimensional data record with respect to a second three-dimensional representation of the object on the basis of the second three-dimensional data record, and for driving an output device for outputting a superimposition of the first three-dimensional representation and the second three-dimensional representation.

An apparatus of such a type may, in particular, have been configured for executing one of the methods discussed above. For example, the second three-dimensional data source may include a stereomicroscope which has been coupled with two cameras. Moreover, the apparatus may include, for example, a cutting apparatus such as a microtome or another manipulating apparatus.

The apparatus may further include an illuminating device which has preferably been coupled with the object in order to excite fluorescent markers, such as fluorescent beads for example, in the object to fluoresce.

### BRIEF DESCRIPTION OF THE DRAWINGS

The invention will be elucidated in greater detail in the following on the basis of embodiments with reference to the appended drawing.

FIG. 1 is a block diagram of an embodiment of an apparatus;

FIG. 2 is a flow chart for illustrating an embodiment of a method;

FIG. 3A is a schematic diagram illustrating one exemplary embodiment of a superimposition of two three-dimensional representations for a left eye of an observer;

FIG. 3B is a schematic diagram illustrating one exemplary embodiment of a superimposition of two three-dimensional representations for a right eye of an observer;

FIG. 3C is a schematic diagram illustrating one exemplary embodiment of a superimposition of the images shown in FIGS. 3A and 3B;

FIG. 4A is a schematic diagram illustrating another exemplary embodiment of a superimposition of two three-dimensional representations for a left eye of an observer;

FIG. 4B is a schematic diagram illustrating another exemplary embodiment of a superimposition of two three-dimensional representations for a right eye of an observer;

FIG. 4C is a schematic diagram illustrating another exemplary embodiment of a superimposition of the images shown in FIGS. 4A and 4B;

FIG. 5A is a schematic diagram illustrating a further exemplary embodiment of a superimposition of two three-dimensional representations for a left eye of an observer;

FIG. 5B is a schematic diagram illustrating a further exemplary embodiment of a superimposition of two three-dimensional representations for a right eye of an observer;

FIG. 5C is a schematic diagram illustrating a further exemplary embodiment of a superimposition of the images shown in FIGS. 5A and 5B;

FIG. 6A is a schematic diagram illustrating still a further exemplary embodiment of a superimposition of two three-dimensional representations for a left eye of an observer;

FIG. 6B is a schematic diagram illustrating still a further exemplary embodiment of a superimposition of two three-dimensional representations for a right eye of an observer;

FIG. 7A is a schematic diagram illustrating yet another exemplary embodiment of a superimposition of two three-dimensional representations for a left eye of an observer;

FIG. 7B is a schematic diagram illustrating yet another exemplary embodiment of a superimposition of two three-dimensional representations for a right eye of an observer;

FIG. 7C is a schematic diagram illustrating yet another exemplary embodiment of a superimposition of the images shown in FIGS. 7A and 7B;

FIG. 8 is a schematic diagram of an embodiment of an apparatus;

FIG. 9 is a perspective view of a part of an apparatus according to an embodiment;

FIG. 10 is a schematic view for elucidating the generation of a three-dimensional representation in some embodiments;

FIG. 11 is a perspective view for elucidating the generation of a three-dimensional representation in many embodiments;

FIG. 12 is a perspective view of a part of an apparatus according to an embodiment;

FIG. 13 is a flow chart for illustrating a method according to an embodiment;

FIG. 14A is an example of a 3D cursor in a first position; and

FIG. 14B is an example of a 3D cursor in a second position.

### DETAILED DESCRIPTION

Embodiments of the present invention will be elucidated in detailed manner in the following. It is to be noted that features and elements of various embodiments can be combined with one another, unless otherwise stated. On the other hand, a description of an embodiment having a plurality of features should not be interpreted to the effect that all these features are necessary for executing the invention, since other embodiments may exhibit fewer features and/or alternative features.

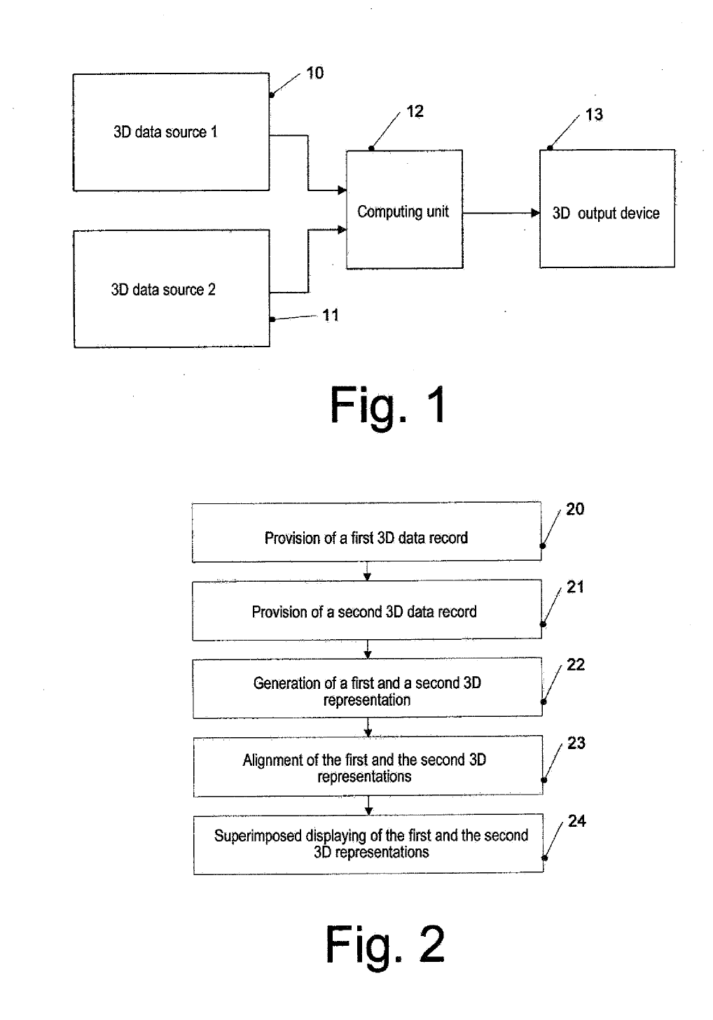

In FIG. 1 a block diagram of an apparatus according to an embodiment of the invention has been represented.

The embodiment shown in FIG. 1 includes a first three-dimensional data source 10, also designated in the following as a 3D data source, for providing a first three-dimensional data record (designated as a 3D data record for short in the following) of an object, and a second 3D data source 11 for providing a second 3D data record of the object. By a “3D data record of an object”, generally a data record is understood that contains, at least partially, information as regards a three-dimensional structure of the object. For example, the 3D data record may represent the object as a ‘scatter diagram’, or the 3D data record may include a stereoscopic view of the object, in which case—particularly in the case of non-transparent objects—substantially information concerning a surface shape is derivable from the data record, whereas information concerning the volumetric structure may also be contained in the case of a scatter diagram.

The first 3D data source 10 and the second 3D data source 11 may, for example, each include measuring devices for acquiring the first and second 3D data record, respectively, by measurement, memories for storing the respective 3D data record, and/or computing devices for generating a 3D data record, for example on the basis of a simulation, for example a wind-tunnel simulation, or on the basis of user inputs, for example with the aid of a CAD (computer-aided design) program. In one embodiment, the first 3D data source 10 includes a memory for saving a 3D data record acquired previously, for example by measurement, whereas the second 3D data source 11 includes a measuring apparatus that continuously renews the second 3D data record and consequently enables a ‘live’ observation of the object. For example, the first 3D data record may have been acquired on the basis of a measurement with a laser scanning microscope or with another device that scans the object, and may have been stored in the first 3D data source 10 (being an example of a ‘scatter diagram’), whereas the second 3D data source 11 may include a stereomicroscope that provides 3D data continuously, in this case stereoscopic views. However, types of measurements other than the aforementioned measurements with a laser scanning microscope and stereomicroscopic measurements are also possible, for example measurements by means of a computer-assisted tomograph (CT), a magnetic-resonance tomograph (MRT), an electron microscope, in particular a scanning electron microscope, or even an ultrasonic scanner. Likewise, appropriate 3D data records may have been gained from geophysical investigations, or may be weather data.

The first 3D data record is made available to a computing unit 12 by the first 3D data source 10, and the second 3D data record is likewise made available to the computing unit 12 by the second 3D data source 11. The computing unit 12 determines a superimposition of a first three-dimensional representation (in the following: 3D representation) of the object on the basis of the first 3D data record, and of a second 3D representation of the object on the basis of the second 3D data record, and outputs this superimposition to a 3D output device 13 with a view to output. The first 3D representation, the second 3D representation and the superimposition may in this method each be, in particular, stereoscopic representations. A determining of the first 3D representation and/or of the second 3D representation in this method may include a rendering of surfaces by means of a renderer, for example in order to generate from a scatter diagram corresponding surfaces for a stereoscopic representation. In this method the computing unit 12, where appropriate in interaction with a user, aligns the first 3D representation relative to the second 3D representation, so that, for example, the object has been shown in both 3D representations from the same perspective, exhibits the same scale and has been represented at the same position.

By a “3D representation” in this method, a representation of the object is to be understood that is suitable for an output on a 3D output device 13. In particular, a 3D representation in this method may include two images of the object, which is supplied via the 3D output device 13 to a left eye and to a right eye, respectively, of an observer, in order consequently to give rise to a three-dimensional impression in the observer. The first image and the second image in this method exhibit two slightly different perspectives, corresponding to human vision. It is to be noted that “a” or, to be more exact, “an” in “3D data record of an object” or “3D representation of an object” is to be understood as an indefinite article and does not rule out the case where several objects are present in the 3D data records or 3D representations.

It is to be noted that if the corresponding 3D data source 10 or 11 is, for example, a stereomicroscope, the 3D data record generated can substantially be used directly by way of 3D representation, since a stereomicroscope of such a type is able to provide, for example, two images from slightly different perspectives.

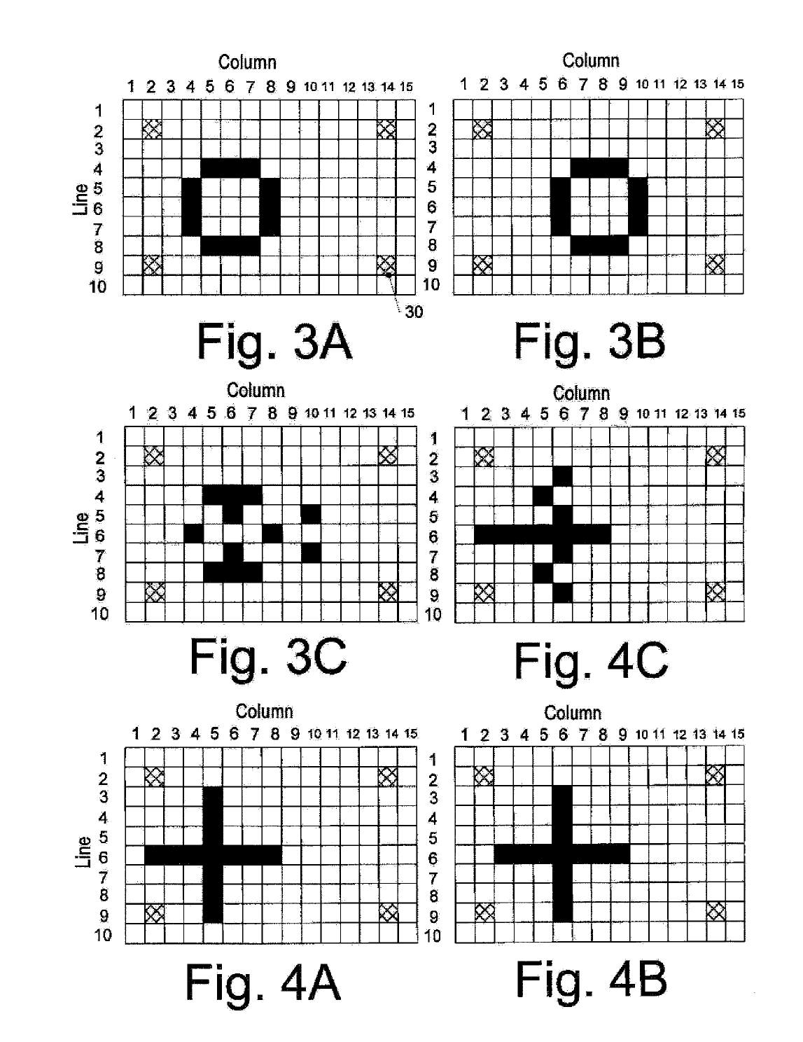

Examples of how the first 3D representation can be superimposed with the second 3D representation will be elucidated in more detailed manner later with reference to FIGS. 3-7.

The 3D output device 13 may be any conventional type of 3D output device. For example, separate displays, for example video screens, for the left and right eye of an observer may have been provided, for example in so-called 3D goggles, or separate images may be supplied via a head-mounted display to the left and right eye of a user. In other embodiments the 3D output device may include a single display which represents an image for a left eye of an observer and an image for a right eye of an observer simultaneously (for example, line-by-line, alternately) with differing polarisation. By means of polarising goggles the images are then separated from one another. In other embodiments an image for the left eye and an image for the right eye can be represented alternately, and by means of so-called shutter goggles the two eyes of the observer can be appropriately covered alternately. In yet other embodiments the separation can be undertaken via colour filters, for example by means of the known red/green goggles.

With the embodiment shown in FIG. 1 it is consequently possible to represent representations of an object originating from differing data sources in superimposed manner, which may facilitate an analysis or a machining of the object.

In FIG. 2 a flow chart has been represented for illustrating a method according to an embodiment of the present invention which, for example, may have been implemented in the apparatus shown in FIG. 1 but may also be used independently of this apparatus.

In step 20 a first 3D data record of an object is provided, and in step 21 a second 3D data record of the object is provided. In step 22 a first 3D representation of the object is generated on the basis of the first 3D data record, and a second 3D representation of the object is generated on the basis of the second 3D data record. In step 23 the first and second 3D representations are aligned with respect to one another, and in step 24 the first and second 3D representations are displayed in superimposed manner, as already described with reference to FIG. 1.

It is to be noted that the various procedures in FIG. 2 that have been described do not necessarily have to be carried out in the sequence represented. For example, the provision of the first 3D data record in step 20 and the provision of the second 3D data record in step 21 may also be undertaken simultaneously or in reverse order. The aligning procedure of step 23 may also be undertaken after the superimposed displaying, for example the superimposed displaying can be utilised by a user for the purpose of an alignment. In yet other embodiments, firstly an automated aligning can be undertaken before the superimposed displaying, and then a fine alignment can be performed on the basis of the superimposed displaying.

As already elucidated, the aligning can be undertaken on the basis of features of the object that are present both in the first 3D data record and in the second 3D data record. For example, the first 3D data record may have been created by a laser scanning micrograph of an object, in which fluorescence of fluorescent beads is visible. The second 3D data record can then be undertaken by recording via a stereoscopic optical microscope, whereby, here too, the fluorescent beads can be excited to fluoresce by an appropriate illumination, so that the fluorescent beads in both cases are visible and consequently can be utilised for the purpose of aligning.

Next, options for superimposed displaying of two 3D representations that can be used in embodiments of the present invention will now be elucidated schematically with reference to FIGS. 3-7.

To do this, for the purpose of illustration use will be made of simple black-and-white symbols in a field having a resolution of 15×10 pixels. In practice, a resolution that is used will frequently be higher by a multiple, for example corresponding to a HDTV resolution of 1920×1080 pixels in colour, in which connection higher or lower resolutions and both black-and-white or grey-level images and colour images are also possible. The simple representation shown in FIGS. 3-7 was accordingly chosen merely in order to be able to give simple examples of the superimposition.

In FIG. 3 a 3D representation of a first object has been represented, which in the embodiment represented is a quadrangular object. In this case, FIG. 3A shows a first image, for example for a left eye of an observer, and FIG. 3B shows a second image, for example for a right eye of an observer. As can be seen, the object in FIG. 3B has been displaced three columns to the right relative to FIG. 3A, i.e. relatively far, corresponding to an object relatively close to an observer.

Moreover, in FIGS. 3A and 3B markings 30 have been provided which, as will be elucidated later, may serve for the purpose of aligning. These markings 30 have the same position in the example represented in FIGS. 3A and 3B, which would correspond to an object far away. In other embodiments the object itself may also have been provided with markings.

In FIG. 4 a 3D representation of a second object, in this case a cross, has been represented, wherein FIG. 4A once more represents a first image, for example for a left eye, and FIG. 4B represents a second image, for example for a right eye. The use of second different objects in FIG. 3 and in FIG. 4 serves for easier differentiation in the following examples of the combining of second 3D representations. As already elucidated above, embodiments of the present invention may serve, in particular, to represent two three-dimensional representations of the same object in superimposed manner, for example two representations in which differing features of the object are visible (for example, since different measuring methods were used in order to generate the two representations). Also in FIG. 4 the markings 30 are present.

In FIG. 4B the cross has been shifted to the right by one column compared with FIG. 4A. Compared with the object shown in FIG. 3, this means that the object shown in FIG. 4 is further away from an observer.

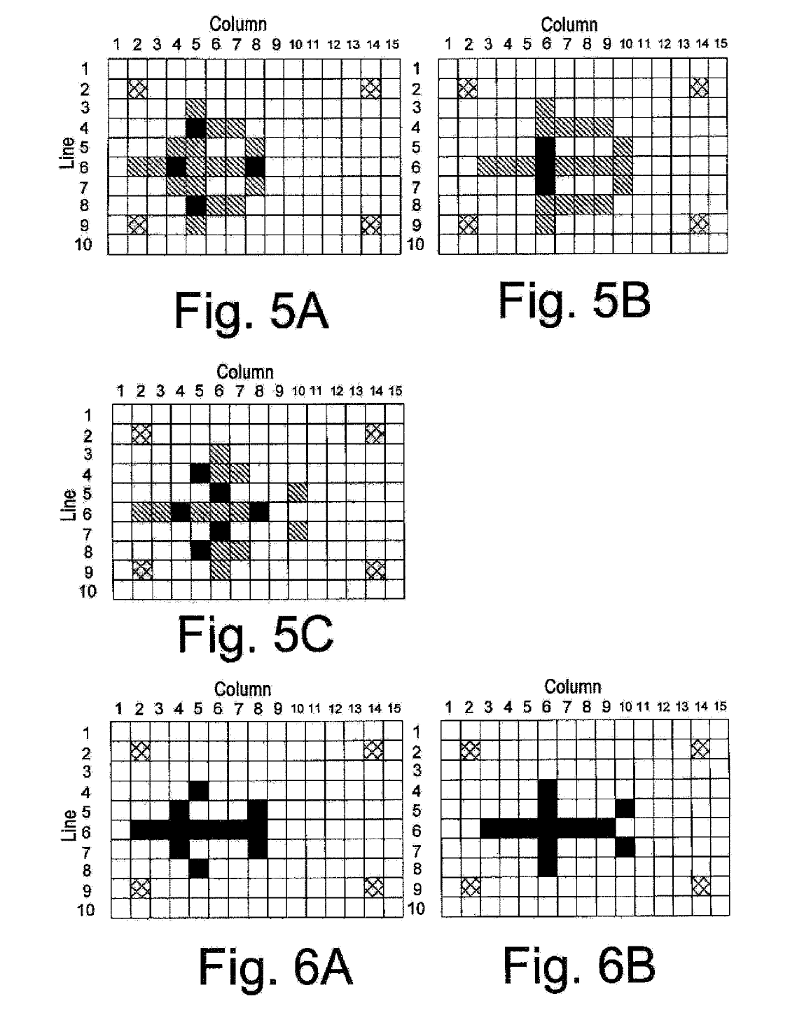

In FIG. 5 a first example of a superimposition of the 3D representation shown in FIG. 3 with the 3D representation shown in FIG. 4 has been represented. In this case, FIG. 5A shows a first image of the superimposed representation, for example for a left eye of an observer, and FIG. 5B shows a second image of the superimposed representation, for example for a right eye of the observer. The alignment could in this case be performed, for example, by means of the markings 30.

In the example shown in FIG. 5, for the purpose of generating the image shown in FIG. 5A the images shown in FIGS. 3A and 4A are added, and then the added values are divided by two, so that an overflow or saturation does not occur. In the case of the simple black-and-white images shown in FIGS. 3A and 4A, this means that pixels that appear black both in FIG. 3A and in FIG. 4A also appear black in the image shown in FIG. 5A, pixels that are black only in one of FIGS. 3A and 4A appear as grey (in FIG. 5A represented in crosshatched manner), and pixels that are white in FIG. 3A and FIG. 4A also appear white in FIG. 5A. In corresponding manner, the image shown in FIG. 5B is also attained by addition of the images shown in FIGS. 3B and 4B, and by subsequent dividing by two. The 3D representation shown in FIG. 5 can then be output once more on a 3D output device as discussed above.

It is to be noted that a superimposition as represented in FIG. 5 can also be undertaken in weighted manner, i.e. not with simple addition of two images but with a weighted addition. Consequently, one representation can be emphasised more strongly in comparison with the other 3D representation. Weighting factors of such a type can be set by a user, for example by means of a slide control of an appropriate user interface.

In FIG. 6 a second example of a superimposed representation of the 3D representations shown in FIGS. 3 and 4 has been represented.

In this case, once more FIG. 6A shows a first image, for example for a left eye of an observer, and FIG. 6B shows a second image for the right eye of an observer.

In the example shown in FIG. 6, the image shown in FIG. 6A is formed from the images shown in FIGS. 3A and 4A, in which alternately a line of the image shown in FIG. 3A and a line of the image shown in FIG. 4A are taken. In other words, the first, third, fifth, seventh and ninth lines of the image shown in FIG. 6A correspond to the first, third, fifth, seventh and ninth lines, respectively, of the image shown in FIG. 3A, and the second, fourth, sixth, eighth and tenth lines of the image shown in FIG. 6A correspond to the second, fourth, sixth, eighth and tenth lines, respectively, of the image shown in FIG. 4A. In corresponding manner, the image shown in FIG. 6B is formed from the images shown in FIGS. 3B and 4B.

It is to be noted that, in other embodiments, provided that an appropriate display device is available, twice the vertical resolution can also be chosen for the superimposed representation, i.e. for the represented example, an image with 20 lines. In this case, the odd lines, for example, can then be formed by the lines of the images shown in FIG. 3, and the even lines can be formed by the lines of the images shown in FIG. 4.

It is further to be noted that a corresponding superimposition in columns is equally possible.

In the case of a line-by-line superimposition as represented, for example in the case of a so-called interlace representation on an appropriate display, in which two half-images are represented in alternation, one half-image can be undertaken on the basis of an image of a first representation, and the other half-image can be undertaken on the basis of an image of a second representation (for example, the representation shown in FIGS. 3 and 4).

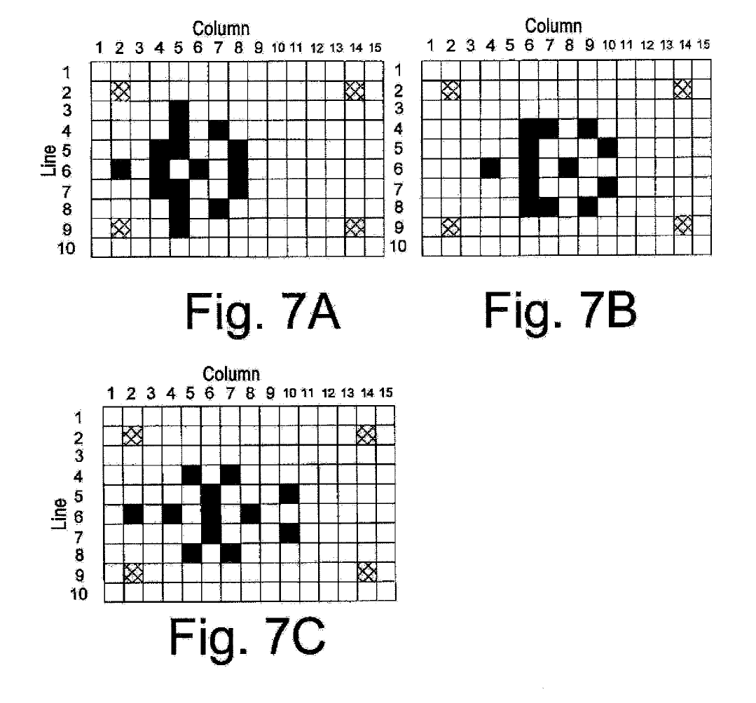

A further possibility of the superimposition of 3D representations has been represented in FIG. 7. Once more, FIG. 7A shows a first image, for example for a left eye of an observer, and FIG. 7B shows a second image, for example for a right eye of an observer.

In this example, the individual representations shown in FIGS. 3 and 4 are superimposed in the manner of a chessboard. In particular, in the case of the image shown in FIG. 7A the pixel in the first line, first column, corresponds to the pixel, first line, first column, shown in FIG. 3A, the pixel, first line, second column, shown in FIG. 7A corresponds to the pixel, first line, second column, shown in FIG. 4A, the pixel, first line, third column, shown in FIG. 7A then corresponds again to the pixel, first line, third column, shown in FIG. 3A etc. In the second line the selection is then, as it were, displaced by one, i.e. the pixel, second line, first column, shown in FIG. 7A corresponds to the pixel, second line, first column, shown in FIG. 4A, the pixel, second line, second column, shown in FIG. 7A corresponds then to the pixel, second line, second column, shown in FIG. 3A etc.

The selection for the other odd lines (third, fifth, seventh and ninth lines) corresponds to the selection of the first line (i.e. in each instance in the first column the pixel from FIG. 3A, in the second column the pixel shown in FIG. 4A etc.), whereas the remaining odd lines (lines 4, 6, 8, 10) correspond to line 2, i.e. first column corresponding to FIG. 4A, second column corresponding to FIG. 3A etc.

Whereas in the example shown in FIG. 7 the superimposition was undertaken “in the manner of a chessboard”, whereby the individual ‘fields’ of the chessboard were individual pixels, the superimposition may also, of course, be done in other patterns, for example with square or rectangular fields which comprise several pixels. For example, for the represented example the first two columns can be taken from the first two columns from the image shown in FIG. 3, columns 3 and 4 can be taken from lines 1 and 2 from FIG. 4 etc., whereas for the third and fourth lines columns 1 and 2 can be taken from FIG. 4, columns 3 and 4 from FIG. 3 etc., so that ‘fields’ of two-times-two pixels would result here.

Also for a chessboard-like superimposition of such a type it is possible that the images of the superimposed representation exhibit a higher resolution than the images of the individual 3D representations, so that in the course of the superimposition fewer or no pixels of the original representations have to be discarded.

Moreover, the various options shown in FIGS. 5-7 can be combined with one another, by various options being employed for various parts of the images of the individual representations.

For example, for the purpose of representation on a stereo monitor, the lines of which exhibit alternating polarisation, so that, for example by means of polarising goggles, the left eye sees only the even lines and the right eye sees only the odd lines (or conversely), the respective images for left eye and right eye can be combined in the representations. Accordingly, FIG. 3C shows a representation in which the images shown in FIGS. 3A and 3B have been combined in such a manner that the even lines shown in FIG. 3A and the odd lines shown in FIG. 3B correspond. Correspondingly, FIG. 4C was generated from FIGS. 4A and 4B. The representations shown in FIG. 3C and FIG. 4C contain, just like the ‘separate’ representations shown in FIGS. 3A, 3B and 4A, 4B, respectively, an image for the left eye and an image for the right eye, these images now having been interlaced, line-by-line.

The superimposition can then be undertaken as already discussed above, e.g. by addition or in the manner of a chessboard. Accordingly, FIG. 5C shows a superimposition by addition, whereas FIG. 7C shows a chessboard-like superimposition.

Whereas the examples that have been represented show merely black-and-white images, a corresponding procedure can be adopted for colour images, by, for example, the possibilities represented being employed separately for each colour channel (ordinarily, red, blue and green).

In a further embodiment, the superimposition is undertaken by the first 3D representation and the second 3D representation being represented alternately. Preferably in this method the alternating frequency is sufficiently high, e.g. 30 Hz or higher, so that an at least substantially flicker-free superimposition is present.

As already elucidated, embodiments of the invention enable a superimposed viewing of three-dimensional representations of an object that originate from various data sources, for example from various types of measurements or from a measurement and a simulation. In particular, in many embodiments of the present invention it is possible to view an object ‘live’ in three dimensions and simultaneously to view, in superimposed manner, a 3D representation based on a 3D data record provided previously.

Embodiments of such a type can be used, as will now be elucidated in greater detail, in particular for the cutting of objects, for example biological objects that have been cast in resin.

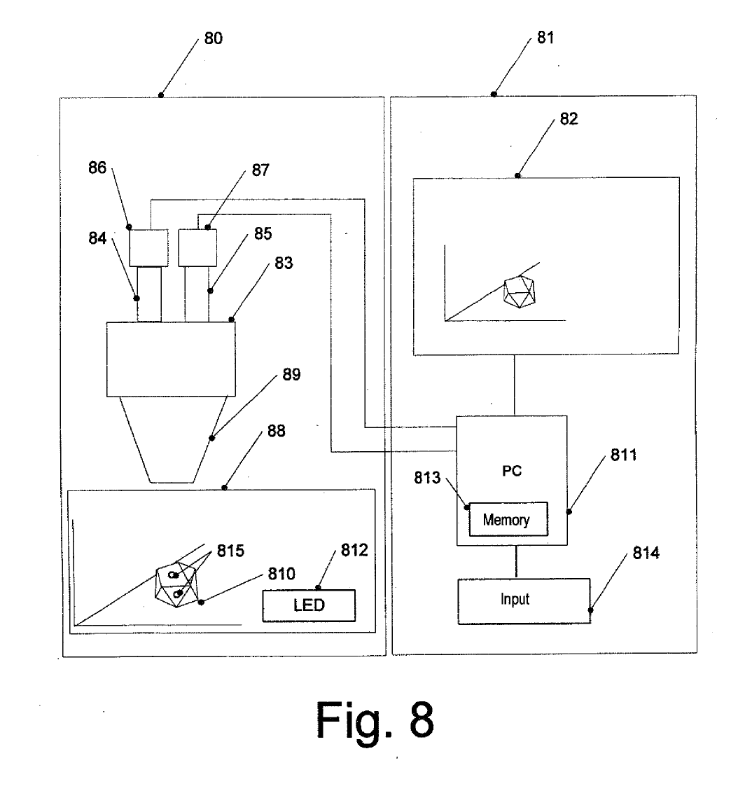

A corresponding embodiment of the present invention has been represented in FIG. 8. The embodiment shown in FIG. 8 includes a stereomicroscope device 80 and a display device 81. The stereomicroscope device 80 includes an object mounting 88, for example a microtome apparatus, which is preferably adjustable in three dimensions and into which an object 810, for example a biological object that has been cast into a resin block, has been clamped.

The object 810 is viewed by means of a stereomicroscope 83 which exhibits an objective arrangement 89, directed onto the object 810, and two eyepiece tubes 84, 85. A first camera 86 has been coupled with eyepiece tube 84, and a second camera 87 has been coupled with eyepiece tube 85. In stereomicroscopes of such a type the objective arrangement conventionally generates an intermediate images which are then viewed with two eyepieces (one for the left eye, and one for the right eye). In the embodiment that is represented, instead of eyepieces the cameras 86, 87 have now been provided. In this embodiment, image sensors of the cameras 86, 87 may, for example, lie in the plane of the aforementioned intermediate image, in order in this way to record the intermediate images. In other embodiments, adapters, i.e. optical systems, may have been additionally provided which adapt the size of the intermediate images to the size of the image sensors, i.e. which reduce or enlarge the intermediate images. In one embodiment, the cameras 86, 87 are high-resolution colour-image cameras, for example cameras with a so-called full-HD resolution of 1920×1080 colour pixels, in which connection other resolutions may likewise be used and, in particular, a resolution that is used may depend on a requisite accuracy and richness of detail of the recording. In many embodiments in this connection the resolution is higher than the resolution used later, and only a section of the image sensor is used. By this means, an adaptation, for example of the section of the first camera 86 to a section of the second camera 87, or conversely, can be facilitated. If, for example, the aforementioned full-HD resolution is used for the further processing, the resolution of the image sensors used may amount in each instance to 2500×1500 colour pixels.

The microscope 83, in particular the cameras 86 and 87, accordingly represent a data source for providing a 3D data record, whereby in this case the 3D data record is a stereoscopic representation as elucidated above and, in principle, can also be used directly as a 3D representation for the purpose of representation on an appropriate 3D output device.

Outputs of the cameras 86, 87 have been connected to a computing unit 811, for example in the form of an appropriately programmed commercial computer (PC) 811. The computer 811 exhibits a memory 813 in which a further 3D data record of the object 810 has been stored, for example on the basis of a preceding measurement, a simulation or a computer-aided design. For example, the 3D data record of the object 810 stored into the memory 813 may have been obtained with a measurement by a laser scanning microscope. From the data record stored in the memory 813 the computer 811 generates a further 3D representation of the object 810, whereby a rendering for generating corresponding surfaces, visible in a stereoscopic 3D representation, can be undertaken, and outputs the 3D representation supplied by the cameras 86, 87 together with the further 3D representation in superimposed manner on a display device 82, for example on a stereo monitor, whereby the superimposition may be undertaken, for example, as described above.

Via the computer 811, moreover the 3D representation gained from the stored data record and the 3D representation gained via the stereomicroscope 83 can be aligned in respect of one another, in particular can be brought to the same size and perspective. In one embodiment, for the purpose of alignment use is made of fluorescent markers, in particular fluorescent beads, which in FIG. 8 have been represented schematically as fluorescent beads 815 in the object 810. Fluorescent markers of such a type are, for example, visible in laser scanning micrographs which may serve as an example of a 3D data record stored in the memory 813.

The computer 811 may, as already mentioned, be programmed appropriately in order to enable a display of the stereo-camera images ‘live’ and simultaneously to enable a 3D representation on the basis of a data record stored in the memory 813. Moreover, functions for storing both individual camera images and stereoscopic pairs of images, as well as a corresponding loading function, can be provided.

In many embodiments, moreover, a selection option for selecting a desired type of superimposition (for example, according to one of FIGS. 5-7) can be provided, and/or a weighting factor between the representations to be superimposed can be set with a slide control, as already mentioned above. An appropriate cursor, in particular a 3D cursor as described further below, for surveying the respectively displayed 3D representations, for example controlled by the input 814, can also be represented. A 3D cursor of such a type can be moved and positioned in all three directions in space and can consequently be used for carrying out measurements in three dimensions. In this method, a calibration by means of a known three-dimensional object, in particular an object of known dimensions, may be undertaken previously.

It is to be noted that in many embodiments a superimposed representation and a non-superimposed representation can also be represented in parallel, for example on different output units.

Moreover, in the case of the apparatus shown in FIG. 8 an illuminating apparatus 812 may have been provided, in particular an illuminating apparatus based on light-emitting diodes (LED), which has preferably been provided directly in the holder for the object 810, so that the light of the light-source 812 is preferably coupled into the object 810 with as little reflection as possible. Instead of light-emitting diodes, other light-sources, preferably sources of cold light, can also be used. A coupling of such a type can be undertaken, in particular, via an edge of the object 810.

By virtue of a light-source 812 of such a type, the fluorescent beads 815 or other fluorescent markers can be made visible under the stereomicroscope 83. In this case, for example, in many embodiments scattered light may be visible by virtue of scattering on the fluorescent markers, or the fluorescent markers may additionally or alternatively be excited to fluoresce by the light-source 812. Consequently, the fluorescent markers are visible both in the 3D data record stored in the memory 813 and in the 3D data record generated by the stereomicroscope 83. For the purpose of aligning, the fluorescent markers can then be made to coincide.

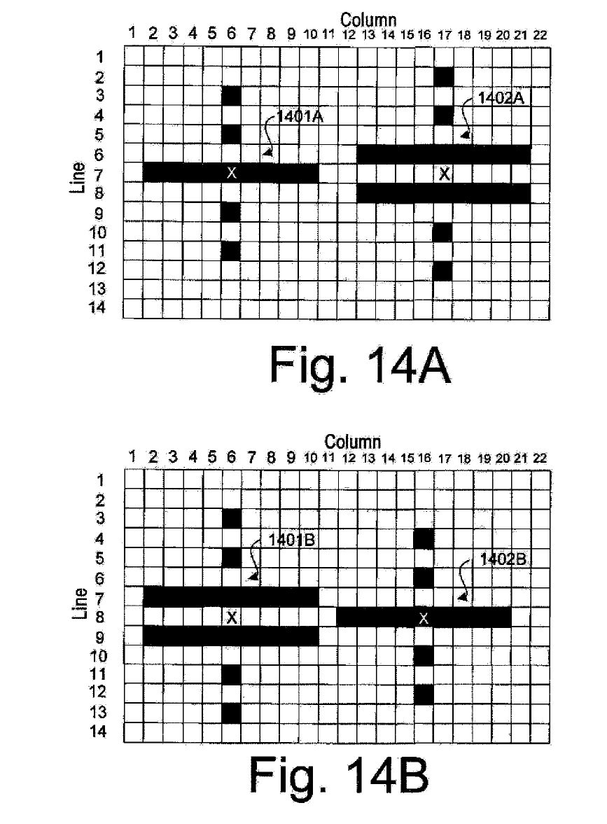

An aligning of such a type may be undertaken in automated manner by means of the computing unit 811, but it may also be undertaken, entirely or partially, manually by a user via an input device 814 which has been coupled with the computer 811. The input device 814 may include conventional input units such as a keyboard, a mouse or a trackball, but it may also include a so-called 3D mouse. In another embodiment, by means of a conventional mouse or a conventional trackball a 3D control, in particular a virtual or real movement of the object in three dimensions, may have been implemented. Such a possibility of a three-dimensional control by means of a conventional mouse has been described in detailed manner in DE 103 58 722 A1, for example. Besides the aforementioned surveying, in this method a 3D cursor may also come into operation for the aligning, for example for the purpose of selecting and/or moving points, said cursor being represented, together with the superimposition of the 3D representations, on the display 82. An example of a representation of a 3D cursor of such a type will now be elucidated with reference to FIG. 14, wherein FIG. 14A shows the 3D cursor in a first position, and FIG. 14B shows the 3D cursor in a second position.

In the case of the representation shown in FIG. 14 it will be assumed that a display device being used (e.g. the display device 82) is a stereo monitor, the lines of which alternately emit differently polarised light. Consequently, by means of suitable polarising goggles or such like the left eye of an observer sees, for example, only the odd lines, and the right eye sees only the even lines (or conversely). In other words, the odd lines form a first image of a stereoscopic representation, and the even lines form a second image of a stereoscopic representation.

In FIG. 14 the 3D cursor exhibits the shape of a cross. A target point marked by the 3D cursor has been labelled by “X”. In FIG. 14A the part of the 3D cursor in the odd lines (i.e. the first image, e.g. for the left eye) has been denoted by 1401A, and the part of the 3D cursor in the even lines (i.e. the second image, e.g. for the right eye) has been denoted by 1402A. Since the target point in FIG. 14A is located in line 7, i.e. in an odd line, which has been assigned only to part 1401A, for part 1402A the lines above and below, i.e. lines 6 and 8, are utilised for the horizontal bar of the cross. In the course of viewing, the 3D cursor then appears as a cross with a horizontal bar three pixels wide and with a vertical bar one pixel wide. Of course, other shapes are also possible.

A movement of the cursor perpendicular to the image plane represented in FIG. 14 is undertaken by a change of the spacing of the parts 1401A, 1401B from one another; a movement in the image plane is undertaken by a simultaneous movement of the parts 1401A, 1401B in the image plane, whereby these two movements may also be superimposed. In this method the representations of the horizontal bars of parts 1401A and 1402A may change from line to line, depending on the part for which the target point is located in an assigned line.

An example of this has been represented in FIG. 14B. Compared with FIG. 14A, the target point has now moved one line down, i.e. into line 8. Since the target point is accordingly now located in a line assigned to the second part (1402B in FIG. 14B), the first part 1401B (odd lines) now exhibits horizontal bars above and below this line, whereas the second part 1402B exhibits a bar in line 8.

Moreover, in FIG. 14B the parts 1401B, 1402B, compared with the parts 1401A, 1402A shown in FIG. 14A, have moved towards one another by one pixel, corresponding to an increasing distance of the 3D cursor from the observer.

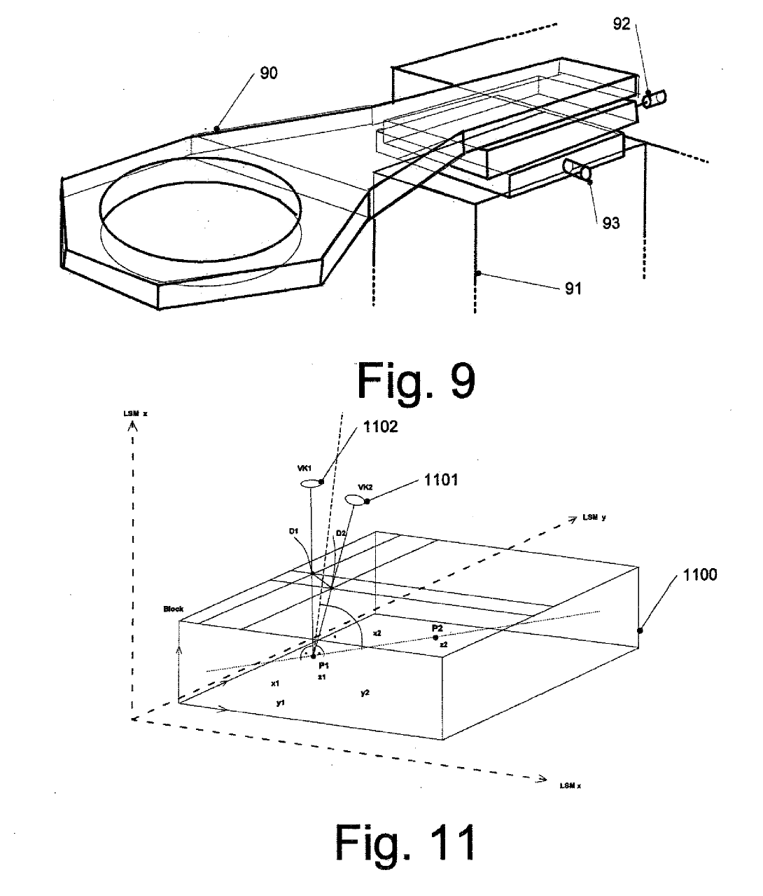

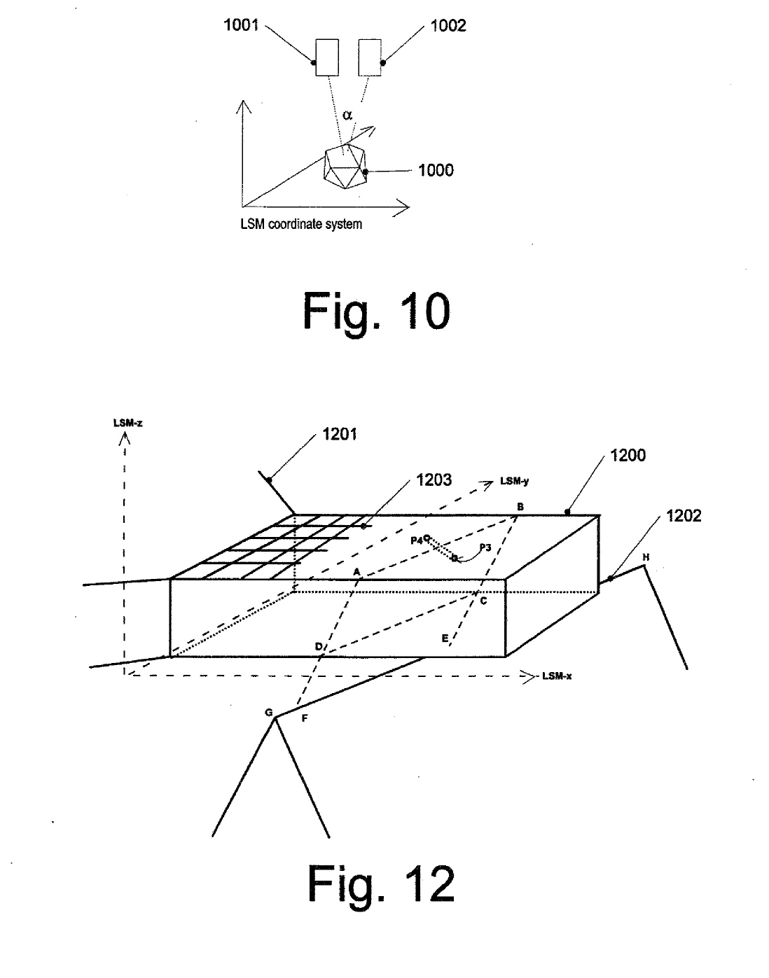

The 3D cursor shown in FIG. 14 serves in this case only as an example, and use may also be made of other representations. Now the aligning in FIG. 8 will be elucidated further. The aligning may, for example, be undertaken by a movement of the object 810 relative to the stereomicroscope 83 (by movement of the object 810 and/or of the stereomicroscope 83) or by a virtual movement of a virtual camera for generating a 3D representation from the data record stored in the memory 813. A combination of these is also possible. These possibilities will now be elucidated in greater detail with reference to FIGS. 9 and 10.

The cameras 86 and 87 can be read out in synchronised manner, in order, for example, to avoid distortions in the case of rapid movements.

It is also to be noted that a superimposition in the embodiment shown in FIG. 8 may take place not only on a separate display 82, but that in many embodiments a stereoscopic pair of images on the basis of the data record stored in the memory 813 may also be faded into an appropriate objective of a stereomicroscope, in order to attain a superimposition.

The memory 813 does not have to have been arranged within the computer 811 but may, for example, also be a memory arranged remotely which the computer 811 can access, for example via a network.

In FIG. 9 a partial view of an apparatus according to an embodiment has been represented, for example a partial view of an apparatus according to the embodiment shown in FIG. 8.

The apparatus shown in FIG. 9 includes a mounting 90 for a measuring apparatus, for example a stereomicroscope such as the stereomicroscope 83 shown in FIG. 8. The mounting 90 has been coupled with an object mounting 91, for example a housing of a microtome, into which the object has been clamped, via a first adjusting table with a micrometer spindle 92 for adjusting in a y-direction and a second adjusting table with a micrometer spindle 93 for adjusting in the x-direction. Measuring callipers may have been integrated into these adjusting options, in order to be able to register the adjustment. Moreover, an adjusting option in the z-direction (not represented) may also have been provided. By virtue of these adjusting options, a measuring apparatus, for example a stereomicroscope, can be aligned precisely with respect to an object, for example in order to attain an alignment of two 3D representations with respect to one another as described.

In FIG. 10 the generation of a 3D representation from a 3D data record has been represented schematically. A 3D data record describes an object 1000 in an appropriate coordinate system; in the case of a generation of the 3D data record by a laser scanning microscope (LSM), in an appropriate LSM coordinate system. For the purpose of generating a 3D representation, this object 1000, which is present as a 3D data record, is recorded with two virtual cameras 1001, 1002. By changing the position of the virtual cameras 1001, 1002, the perspective changes, and consequently the 3D representation may have been adapted to another 3D representation, for example based on a stereoscopic micrograph.

In the case of the use of a stereomicroscope as in the embodiment shown in FIG. 8, an angle α between the virtual cameras 1001, 1002 corresponding to a viewing angle between cameras coupled with the stereomicroscope, for example the cameras 86, 87 shown in FIG. 8, is preferably chosen so that the 3D representations generated can be superimposed without difficulty. Such angles are, for example, of the order of magnitude of ±5.5° with respect to the perpendicular (corresponding to an angle α=11°).

For the purpose of aligning the 3D representations, moreover a registration will, if necessary, be performed, so that the representations have the same scale, for example the representations by means of the stereomicroscope and the representations by means of the laser scanning microscope. For this purpose, known properties—such as, for example, a block surface of an object, for example a height profile—can be utilised, in order to calculate a transformation from the LSM coordinate system into a coordinate system of the stereomicroscope. A transformation of such a type and the determination of parameters and correspondences needed for this can be undertaken automatically, for example by means of features of the object, or appropriate parameters can be predetermined by a user.

Only as an example, by means of a laser scanning microscope, for example, a volume of the order of magnitude of 100 μm×100 μm×100 μm can be registered, whereas with the stereomicroscope a volume of, typically, for example, 1.6 mm×900 μm×200 μm can be registered, so that, for example, from the data record supplied by the stereomicroscope a corresponding section can be chosen or the 3D representation on the basis of the data record stemming from the LSM recording can be superimposed only on a corresponding section of the representation on the basis of the stereomicroscope. The volume registered by the stereomicroscope in this method is dependent on an enlargement provided by the stereomicroscope. In many embodiments an enlargement of such a type can be set. In this case, a set enlargement can be registered automatically and can be communicated to a computing unit such as the computer 811 shown in FIG. 8, which can then take this enlargement into account appropriately in the course of the superimposition and adaptation of the sections.

In many embodiments the object can be moved, for example during a manipulation—such as, for example, a cutting—under the stereomicroscope 83 shown in FIG. 8. In an embodiment of such a type, synchronously with this a ‘movement’ of the virtual cameras 1001, 1002 shown in FIG. 10 can take place, so that the superimposed 3D representations continue to correspond. In other embodiments the superimposed representation is undertaken only in a position of rest, and no tracking takes place during the actual cutting procedure.

Consequently, in the course of the superimposed display of the two 3D representations a correct orientation in space with respect to both rotation and also position and translation can be established.

As already mentioned, methods and apparatuses according to the invention can be used in many embodiments, in particular, for the purpose of manipulating objects, for example for the purpose of cutting objects. In this case, during the manipulation a viewing can be undertaken through a stereomicroscope, while simultaneously in superimposed manner data from other measurements or simulations or even design data (CAD data) are superimposed.

This can, for example, be useful when in the course of a measurement, for example an LSM measurement, in an object that has been cast in a resin block, for example a biological object, a region of interest is discovered which has to be examined further in another way, for example with an electron microscope. For the purpose of electron-microscopic examination of the region of interest, precisely this site of interest has to be exposed, in order firstly to enable the electron-microscopic examination. In this method it is necessary to hit the site to be examined exactly in the course of the exposure, and, above all, not to remove too much.

Objects of such a type that have been cast and prepared with fluorescent markers are used, for example, in virus research.

With an apparatus of the present invention an exposure of such a type can be undertaken, for example, by cutting in a microtome under stereomicroscopic observation, while simultaneously an image from another measurement, for example an LSM measurement, is superimposed, so that the site of interest, which has been marked where appropriate in the LSM data record, is readily recognisable and consequently the exposing can be controlled precisely, for example by cutting.

This will now be elucidated further with reference to FIGS. 11 to 13.

In FIG. 11 an object 1100 which is present as a 3D data record, for example a resin block as described above, has been represented in an LSM coordinate system (the axes have been denoted by LSMx, LSMy and LSMz). 1102 and 1101 denote virtual cameras corresponding to the cameras 1001 and 1002 shown in FIG. 10. In the example that is represented, a cut is to be made in a direction P1-P2, for example, whereby point P1 in the LSM coordinate system exhibits the coordinates (x1, y1, z1), and point P2 exhibits the coordinates (x2, y2, z2). In FIG. 11, accordingly, an example of an LSM data record has been represented.

FIG. 12 shows a corresponding real object 1200, for example a resin block with a specimen to be examined located therein, which widens in a region 1201 and then has been fastened by the region 1201 to a block clamp and is to be cut by means of a cutting knife 1202 of a microtome. A cutting feed, for example in order to cut the object 1200 in stepwise manner, is undertaken in a direction P3-P4. Point P3 lies in this case in a current cutting plane A, B, C, D, with line P3-P4 being perpendicular to this cutting plane. The surface A, B, C, D finds its continuation in the cutting face of the blade 1202 and strikes the latter at points E and F on a line G-H which forms the anterior cutting edge. Moreover, in FIG. 12 the LSM coordinate system and also, indicated as a grid, a block coordinate system 1203 have been represented. For the purpose of cutting, in this case the blade 1202 may be stationary and the object 1200 may be moved, or the object 1200 may be stationary and the blade 1202 may be moved.

By superimposition of a 3D representation on the basis of the LSM data record, under a stereomicroscope being used a region of interest can be identified exactly during the viewing with the stereomicroscope after appropriate alignment, facilitating an exact cutting.

It is to be noted that firstly a coarse cut, for example by means of a mini circular saw or such like, can be carried out on the block 120 before the fine cut is then generated by means of the blade 1202.

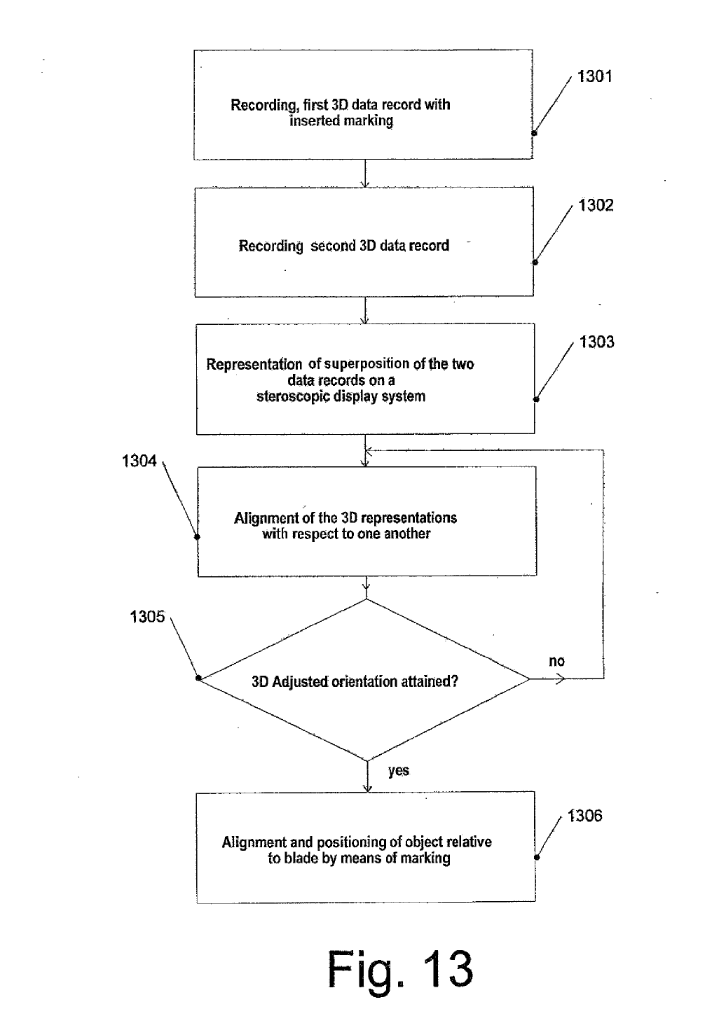

In FIG. 13 a flow chart for illustrating an embodiment of a method for cutting an object has been represented.

In step 1301 a first 3D data record is recorded, for example by means of a laser scanning microscope. In the method a marking can be inserted at a site of interest, in order to facilitate a later identification or a later rediscovery of the site of interest.

In step 1302 a second 3D data record is recorded, for example with a stereomicroscope. The recording of the second 3D data record may in this case be repeated continuously, as already described, in order to provide a ‘live’ image of the object.

In step 1303 a superimposition of 3D representations based on the two data records is represented on a stereoscopic display system as elucidated.

In step 1304 the 3D representations are aligned with respect to one another as described. In step 1305 a check is made as to whether the 3D adjusted orientation has been attained, i.e. the alignment is correct. If no, at 1304 a renewed alignment is performed. If yes, in step 1306 the object is positioned relative to a blade, for which purpose the marking can be used, in order to be able to carry out a cutting at the marking. Subsequently the cutting procedure is then carried out.

As already elucidated with reference to FIG. 2, the aligning (steps 1304 and 1305) may also be undertaken at least partially before the representation (step 1303), or the first and second 3D data records may be recorded parallel to one another or in reverse sequence.

From the above comments it is evident that the invention is not limited to the concrete embodiments represented, since a large number of modifications and variations are possible.

What is claimed is:

1. A method, comprising:
providing a first three-dimensional data record of an object,
providing a second three-dimensional data record of the object,
relatively aligning a first three-dimensional representation of the object based upon the first three-dimensional data record with respect to a second three-dimensional representation of the object based upon the second three-dimensional data record and
superimposed displaying of the first three-dimensional representation and of the second three-dimensional representation.

2. The method according to claim 1, wherein one or more of the provision of the first three-dimensional data record or the provision of the second three-dimensional data record comprises generating the first three-dimensional data record or of the second three-dimensional data record based upon a computer-aided design, a simulation, a wind-tunnel simulation, a geophysical investigation, weather data, a computerised-tomography measurement, a magnetic-resonance-tomography measurement, a stereomicroscopic measurement, a measurement with a laser scanning microscope, a micrograph, an ultrasonic measurement and/or an electron micrograph.

3. The method according to claim 1, wherein the provision of the first three-dimensional data record of the object includes providing a marking of a region of interest of the object in the first three-dimensional data record.

4. The method according to claim 1, wherein the provision of the second three-dimensional data record comprises a continuous renewing of the second three-dimensional data record.

5. The method according to claim 4, wherein the second three-dimensional data record is provided by recording with a stereomicroscope.

6. The method according to claim 5, further comprising:
illuminating the object under the stereomicroscope to make visible fluorescent markers in the object visible.

7. The method according to claim 1, wherein the relative aligning is carried out based upon features of the object that are present both in the first three-dimensional data record and in the second three-dimensional data record.

8. The method according to claim 7, wherein the features of the object include fluorescent markers.

9. The method according to claim 1, which further comprises manipulating the object during the superimposed displaying.

10. The method according to claim 9, wherein the manipulating includes a cutting.

11. The method according to claim 1, wherein:
the first three-dimensional representation comprises a first image for a left eye of an observer and a second image for a right eye of an observer;
the second three-dimensional representation comprises a third image for the left eye of the observer and a fourth image for the right eye of the observer; and
the superimposed displaying comprises combining of the first image with the third image to yield a fifth image for the left eye of the observer and combining of the second image with the fourth image to yield a sixth image for the right eye of the observer.

12. The method according to claim 11, wherein the combining comprises one or more of:
a weighted or non-weighted adding of the images;
a line-by-line or column-by-column alternating combining of the images; or
a chessboard-pattern-like combining of the images.

13. An apparatus, comprising:
a first data source providing a first three-dimensional representation of an object;
a second data source providing a second three-dimensional representation of an object; and
a computing unit programmed to relatively align a first three-dimensional representation of the object based upon the first three-dimensional data record with respect to a second three-dimensional representation of the object based upon the second three-dimensional data record and to drive a three-dimensional output device outputting a superimposed display of the first three-dimensional representation and of the second three-dimensional representation.

14. The apparatus according to claim 13, wherein:
the first three-dimensional data source comprises a memory storing laser-scanning-microscope data pertaining to the object;
the second data source comprises a stereomicroscope with a first camera and with a second camera programmed to continuously renew the second three-dimensional data record; and
the apparatus further comprises a microtome apparatus holding and cutting the object.

15. The apparatus according to claim 13, wherein one or more of the first data source or the second data source comprises a simulation device, a geophysical investigation device, a weather data measuring device, a computer tomography device, a magnetic resonance tomography device, a stereomicroscope, a laser scanning microscope, an ultrasonic device and/or an electron micrograph device.

16. The apparatus according to claim 13, wherein the second data source comprises a stereomicroscope.

17. The apparatus according to claim 16, further comprising: an illumination to illuminate the object under the stereomicroscope and make visible fluorescent markers in the object.

18. The apparatus according to claim 13, wherein:
the first three-dimensional representation comprises a first image for a left eye of an observer and a second image for a right eye of an observer;
the second three-dimensional representation comprises a third image for the left eye of the observer and a fourth image for the right eye of the observer; and
the superimposed display comprises a combination of the first image with the third image to yield a fifth image for the left eye of the observer and a combination of the second image with the fourth image to yield a sixth image for the right eye of the observer.
